(19) United States
(12) Patent Application Publication
(10) Pub. No.: US 2018/0149440 A1
(43) Pub. Date: May 31, 2018

(54) SMART GUN

(71) Applicant: MAURIUS MIREUS, SOUTH EAST PALM BAY, FL (US)

(72) Inventor: MAURIUS MIREUS, SOUTH EAST PALM BAY, FL (US)

(21) Appl. No.: 15/362,301

(22) Filed: Nov. 28, 2016

(51) Int. Cl. F41A 17/06; G06K 9/00; G01S 19/13

(52) U.S. Cl. CPC F41A 17/066; G06K 9/00013; G01S 19/13; G06K 9/00979; G06K 9/00087

(57) ABSTRACT

A smart gun communicating over a communication network. Wherein, the smart gun includes a gun with a chip on the trigger for initiating firing the gun; a finger scanner, positioned on the trigger of the gun,

Configured to scan a fingerprint of the user pulling the trigger of the gun; and a smart chip, coupled to the trigger, configured to communicate the fingerprint over the communication network to a law enforcement agency. Wherein, the smart chip may send a message and/or GPS location of the gun over the communication network to the law enforcement agency and/or the authorized user when the fingerprint does not match the authorized user.

### BACKGROUND OF THE INVENTION

### 1. Field of the Invention

The present invention generally relates to a smart gun and more particularly relates to a smart gun for providing instant user-authentication.

### 2. Description of Related Art

Gun safety is a paramount issue in today's society. Advocacy groups on both sides of the “Gun Control” issue support the development of devices which prevent unauthorized gun use. Such restrictions are commonly endorsed as means for preventing gun use by children and criminals. Accordingly, efforts have been made to incorporate firearms with devices, which restrict or control use.

Several devices have been developed to address this need for firearm safety devices. For instance, various gun safety devices are known which use finger or hand print data in identifying authorized users and enabling operation. Similarly, various gun safety devices use voice recognition circuitry for identifying authorized users and enabling operation.

Some of the above firearm safety devices operate on the firearm's safety latch, whereby the safety latch can only be disabled by an authorized user. However, the safety latch is an important element of a firearm, which allows an authorized user to disable the firearm so as to prevent accidental firing.

Safety issues have utmost priority in the context of consistent illegal gun crime happening in the different states of the USA and around the world. Considering the increased incidents of mass shooting in recent times at vulnerable targets such as educational institutions, health institutions, community centers and theaters, it is a major concern to prevent unauthorized firing of guns and other firearms to ensure the safety of the people present in the area.

Though it is a right of every citizen to own firearms for personal safety, there is a strong need have a system that can help in law enforcement by possessing a robust authentication system to allow the firing of the firearm, and to verify the location of the firearm at any given time to avoid its misuse in a prohibited area. Thus, there is a need of a system to have features that may selectively enable and disable the working of a firearm in a specified geographical area.

Some prior art has been involved in the area of fingerprint scanning and other smart gun operations, wherein the following patents are herein incorporated by reference for their supportive teachings, wherein U.S. Pat. No. 6,317,508, granted Nov. 13, 2013, teaches a scanning capacitive semiconductor fingerprint detector.

Therefore, there is a need of a smart gun that does not require disassembly of the firearm, does not tamper with the firearm safety latch, and controls the actuation of a firearm by reference to an essential element of the firing mechanism. Further, the smart gun should be able to transmit the authentication of user in real-time over a communication network. Furthermore, the smart gun should be able to transmit the GPS location over the communication network.

### SUMMARY OF THE INVENTION

In accordance with teachings of the present invention, there is a smart gun communicating over a communication network, and having a gun with a trigger for initiating firing the gun; a finger scanner, positioned on the gun, configured to scan a fingerprint of the user holding the gun; and a smart chip, coupled to the finger scanner, configured to communicate the fingerprint over the communication network to a law enforcement agency.

Another feature of the invention may to have the smart chip further communicates a GPS location of the gun over the communication network when the authorized user shoots the gun.

Yet, an additional feature of the invention may be to have the smart chip is programmed to only allow the gun to shoot when the fingerprint matches the authorized user of the gun.

Another feature may be to have the smart chip programmed to send a message and/or GPS location over the communication network to the law enforcement agency and/or the authorized user when the fingerprint does not match the authorized user.

Other features that may be part of the present invention are: a) once the trigger is pulled the bullet should release within 0.02 second or less; b) Once the trigger is touch a user, it should scan and recognize the owner's print within 0.02 second or less; c) once the weapon is active by an authorized user, the gun should remain active for uninterrupted and easy access, unless the trigger reads that someone else has now touched the trigger/scanner; and d) there should be no extra work required for the owner, once the trigger is touched, and active, so that the weapon should be operable as if the chips is never even present.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a perspective view of a smart gun communicating over a communication network in accordance with a preferred embodiment of the present invention.

### DETAILED DESCRIPTION OF DRAWINGS

While this technology is illustrated and described in a preferred embodiment a smart gun communicating over a communication network may be produced in various shapes, sizes, colors, and configuration. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

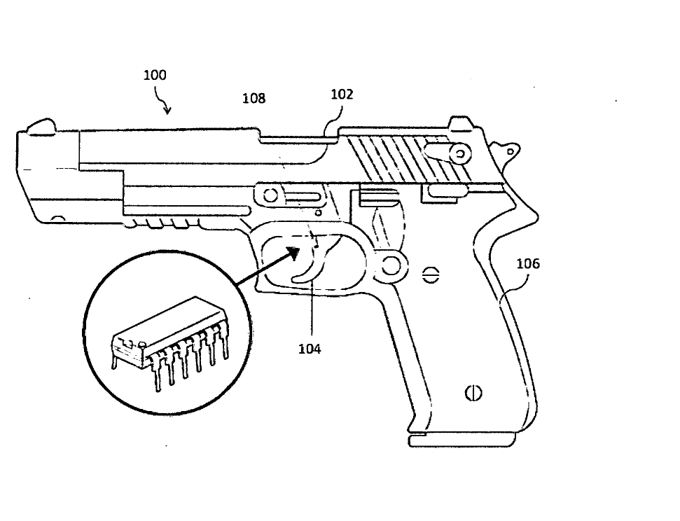

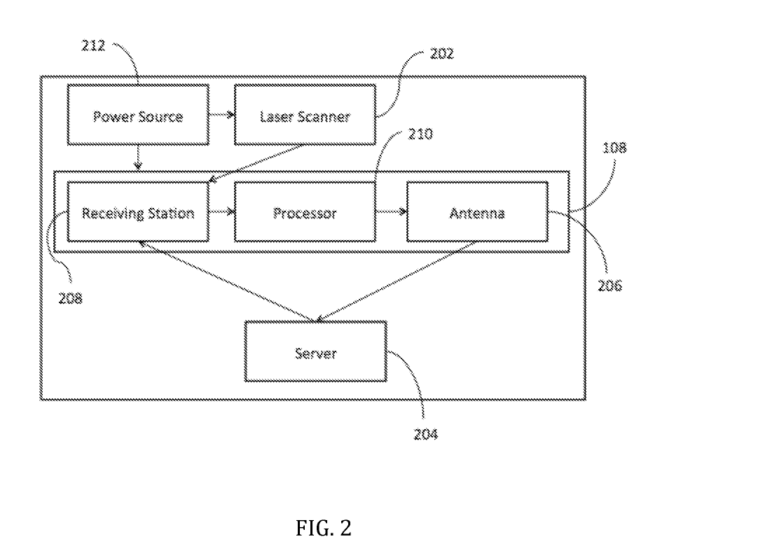

FIG. 1 illustrates a perspective view of a smart gun 100 communicating over a communication network in accordance with a preferred embodiment of the present invention. The smart gun 100 includes a gun 102 having a trigger 104 for initiating firing of a firearm, and a handle 106, a laser scanner configured in the handle 106 to scan the fingerprints of the shooter holding the gun 102, and a smart chip 108 configured in the trigger 104 to communicate the fingerprint over the communication network when the shooter triggers from the trigger 104 and further the smart chip 108 receives command over the communication network in order to control the trigger 104.

The fingerprint scan of the shooter is used by government agencies to monitor the use of gun. The fingerprint scan may be used to catch hold of all unauthorized shooters. The smart chip 108 is able to determine, record, and authenticate the shooter from the fingerprint scanned from the laser scanner. In another preferred embodiment of the present invention, the smart chip 108 may be further programmed wirelessly over the communication network to block the trigger to be pulled to shoot if the user is not authenticated.

In another preferred embodiment of the present invention, the smart chip 108 further communicates GPS location of the gun 102 over the communication network when the shooter triggers from the trigger 104. The smart chip 108 is further programmed to activate the trigger 104 to allow the shooter to shoot only upon detecting the fingerprint of the owner of the gun 102. Further in another preferred embodiment of the present invention, the trigger 104 is locked if the smart chip 108 is tampered.

FIG. 2 illustrates a block diagram to show the process flow in between the smart chip 108, the laser scanner 202 and a server 204. In a preferred embodiment of the present invention, the smart chip 108 includes an antenna 206 operatively associated with the laser scanner for sending fingerprint over the communication network. Alternatively, the antenna 206 also communicates GPS location of the gun 102 over the communication network to the server 204. The server 204 is accessible by the security agencies and law enforcement agencies.

Further, the smart chip 108 includes a receiving station 208 to receive commands over the communication network. The receiving station may receive details about authentication of fingerprint from the laser scanner 202. Further, the receiving station 208 may receive commands from the server 204 to either lock or unlock the trigger.

The smart chip 108 further includes a processor 210 to process the commands and fingerprint signals received from the received station 208, and further transmits the fingerprint details to the server 204 via the antenna 206. The server 204 authenticates the fingerprint and sends the authentication signals to the processor 210 via the receiving station 208.

Further, if the fingerprint is authenticated, then the processor allows the shooter to shoot the firearm by pulling the trigger. If the fingerprint is not authenticated then the trigger is locked on the direction of the processor. Thus, the present invention is able to prevent gun violence by locking the trigger if the fingerprint is not authenticated. Otherwise, the shooter would think twice before shooting, as being aware that their details are already there with the security or law enforcement agencies.

In another preferred embodiment of the present invention, the smart gun 100 further includes a battery 212. The battery 212 powers the smart chip 108 and the laser scanner 202. Examples of communication network includes, but not limited to, internet, Bluetooth, near-field communication, or any other similar communication techniques.

Further, the smart gun 100 includes a key switch to turn on/off the GPS location. For exemplary purposes, the key switch may be used for hunting purposes. The owner can selectively on and off the GPS location. Further, the smart gun 100 does not shoot if the smart chip 108 is not serviced once tampered.

Other features that may be part of the present invention are: a) once the trigger is pulled the bullet should release within 0.02 second or less; b) Once the trigger is touch a user, it should scan and recognize the owner's print within 0.02 second or less; c) once the weapon is active by an authorized user, the gun should remain active for uninterrupted and easy access, unless the trigger reads that someone else has now touched the trigger/scanner; and d) there should be no extra work required for the owner, once the trigger is touched, and active, so that the weapon should be operable as if the chips is never even present.

The present invention offers various advantages such as to reduce/possibly eliminate the gun violence from the society. The present invention is able to determine, record, and identify the shooter. The present invention is blessing for innocent people, gun manufactures, civilians, as well as police and military officers worldwide. The details of the shooter would be recorded and verified at the server and would be used to identify criminals associated with gun violence in the society.

Therefore, one skilled in the art will realize many advantages of the present invention. For example, there is a smart gun communicating over a communication network, and having a gun with a trigger for initiating firing the gun; a finger scanner, positioned on the gun, configured to scan a fingerprint of the user holding the gun; and a smart chip, coupled to the finger scanner, configured to communicate the fingerprint over the communication network to a law enforcement agency. Additionally, the smart chip may communicate a GPS location of the gun over the communication network whenever any user shoots the gun. Further, the smart gun may have the smart chip programmed to only allow the gun to shoot when the fingerprint matches the authorized user of the gun. The invention may also have the smart chip programmed to send a message and/or GPS location over the communication network to the law enforcement agency and/or the authorized user only when the fingerprint does not match the authorized user. Additionally, the smart chip will save the authorized fingerprints therein so that there is no delay in authorizing the fingerprints when the smart gun trigger is touched.

One skilled in the art of gun operation and security firing measures will easily understand that there are many methods for stopping the operation of a gun being fired, especially when a fingerprint does not match an authorized users fingerprint. For example, there may be a firing pin deactivation device that moves the firing pin from being able to engage the bullet. Another method may be to have the trigger locked in an inoperative position if the fingerprints do not match the authorized users. And there are many other ways, wherein the invention described herein, is not concerned with the exact method used to prevent the physical firing of the weapon, but is focused on a method to inform proper authorities and the authorized user when there is miss use of the gun.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

I claim the following:

1. A smart gun communicating over a communication network, comprising:
a gun having a trigger for initiating firing the gun;
a finger scanner, positioned on the gun, configured to scan a fingerprint of the user holding the gun; and
a smart chip, coupled to the finger scanner, configured to communicate the fingerprint over the communication network to a law enforcement agency.

2. The smart gun according to claim 1, wherein the smart chip further communicates a GPS location of the gun over the communication network when the authorized user shoots the gun. The smart gun according to claim 1, wherein the smart chip is programmed to only allow the gun to shoot when the fingerprint matches the authorized user of the gun.

4. The smart gun according to claim 1, wherein the smart chip is programmed to send a message over the communication network to the law enforcement agency when the fingerprint does not match the authorized user.

5. The smart gun according to claim 1, wherein the smart chip is programmed to send a GPS location over the communication network to the law enforcement agency when the fingerprint does not match the authorized user.

6. The smart gun according to claim 1, wherein the smart chip is programmed to send a message over the communication network to the authorized user when the fingerprint does not match the authorized user.

7. The smart gun according to claim 1, wherein the smart chip is programmed to save an authorized fingerprint thereon.
